(19) United States
(12) Patent Application Publication
(10) Pub. No.: US 2007/0110942 A1
(43) Pub. Date: May 17, 2007

(54) Novel enhanced high temperature tapes for high velocity Oxy fuel processes

(75) Inventors: Jaykumar J. Shah, Wayne, NJ (US); Jian Ling Ding, Glastonbury, CT (US); Timothy Kowal, Windsor, CT (US)

Correspondence Address: GREENBERG TRAURIG LLP, 2450 COLORADO AVENUE, SUITE 400E, SANTA MONICA, CA, 90404, US

(73) Assignee: Scapa North America

(21) Appl. No.: 11/353,613

(22) Filed: Feb. 14, 2006

Related U.S. Application Data
(60) Provisional application No. 60/652,693, filed on Feb. 14, 2005.

(51) Int. Cl. B32B 7/12

(52) U.S. Cl. 428/40.1; 428/354

(57) ABSTRACT

A finished high velocity oxy fuel (HVOF) tape used with, for example, during known HVOF processing imparts high temperature silicone pressure sensitive adhesives that provide enhanced adhesion strength to provide a firm adhesion to its own backing and unexpectedly leave no residue upon removal from metals. The novel enhanced tapes are made up of coated or uncoated, woven or non-woven glass cloth and ceramic based fabric laminated to at least one side of a metal-foil using a silicone based laminating adhesive, which is then laminated with another layer of a pre-selected combination of the same materials and coated with a high temperature silicone pressure sensitive adhesive and wound to itself to make a self wound tape or covered adhesive assembly with a release liner to make a laminated sheet for die cut samples, among other things. Applications including military and commercial aircraft, automobiles and metal finishing usages leverage of on the unique and inherent benefits of the novel enhanced tapes of the instant teachings.

This application is related to and claims the priority of U.S. Provisional Application No. 60/652,693 filed on Feb. 14, 2005, which is hereby expressly incorporated by reference in its entirety.

### BACKGROUND OF THE DISCLOSURE

The present disclosure relates to technologies using plasma and thermal spray processes for the deposition of thin films and coatings in addition to related types of manufacturing processes. In particular, the present disclosure relates to improvement of High Velocity Oxy Fuel (HVOF) tapes used with industrial manufacturing methods including, but not limited to, plasma and thermal spray processes for alloys, ceramics, and related types of materials generally functioning to surmount the issues of excessive wear and high stress on surfaces.

Tapes for HVOF thermal processes, for example, characterized by temperatures which can exceed 600 degrees Fahrenheit and greater than 21,000 miles per hour for fuel velocity, are a longstanding need yet to be adequately addressed in aircraft, automobiles, and metal finishing industry terms.

Common among known high temperature tapes are breakdowns or related mechanical integrity challenges such as unravelings, separation from their own backings, and the like unacceptable failure modes. No known tapes including those made with high temperature carriers are effective to withstand the above noted conditions. Further, metal deposition in unwanted areas, and related contaminations are not industrially accepted and require increased cost, time, and reworking efforts.

### SUMMARY OF THE DISCLOSURE

A finished HVOF tape used, for example, during known HVOF processing imparts high temperature silicone pressure sensitive adhesives that provide enhanced adhesion strength to provide a firm adhesion to its own backing and unexpectedly leave no residue upon removal from metals. The novel enhanced HVOF tapes are made up of coated or uncoated, woven or non-woven glass cloth and ceramic based fabric laminated to at least one side of a metal foil using a silicone based laminating adhesive, which is then laminated with another layer of a pre-selected combination of the same materials and coated with a high temperature silicone pressure sensitive adhesive and wound to itself to make a self wound HVOF tape or covered adhesive assembly with a release liner to make a laminated sheet for die cut samples, among other things. Applications including military and commercial aircraft, automobiles, and metal finishing usages leverage off of the unique and inherent benefits of the novel enhanced HVOF tapes of the instant teachings.

According to features of the present disclosure, there is provided a multilayered laminated HVOF tape comprising, in combination a plurality of layers including having at least: a first layer; a third layer, further comprising any one of the group consisting of: aluminum foil, steel foil, copper foil, wool paper, polyamide paper, and polyamide woven fabric; a first adhesive layer; a glass cloth layer, wherein the glass cloth layer is a glass or ceramic fiber that is either woven or felt; a second adhesive layer; wherein the resulting HVOF tape which provides for high strength and non-flammable resistance to high temperature, high velocity, and high pressure when used during an HVOF process.

According to features of the present disclosure, there is provided a multilayered laminated HVOF tape comprising, in combination: a plurality of layers including having at least: a glass cloth layer; a first layer; a third layer, further comprising any one of the group consisting of: aluminum foil, steel foil, copper foil, wool paper, polyamide paper, and polyamide woven fabric; a second adhesive layer; wherein the resulting HVOF tape which provides for high strength and non-flammable resistance to high temperature, high velocity, and high pressure when used during an HVOF process.

According to features of the present disclosure, there is provided a multilayered laminated HVOF tape comprising, in combination: a first release liner; a first high temperature silicone pressure sensitive adhesive; one of a first high temperature fabric and a high temperature silicone foam; a first laminating adhesive; one of a metal foil and a silicone foam; a second laminating adhesive; a second high temperature fabric; a second high temperature silicone pressure sensitive adhesive; and a second release liner.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a pictorial representation of the present disclosure.

FIG. 2 is a schematized view of an embodiment of the teachings of the present disclosure, showing the same as used in conjunction, for example, with conventional HVOF processing.

FIG. 3 is a schematized view of an embodiment of the teachings of the present disclosure, showing the same as used in conjunction, for example, with conventional HVOF processing.

FIG. 4 is a schematized view of an embodiment of the teachings of the present disclosure, showing the same as used in conjunction, for example, with conventional HVOF processing.

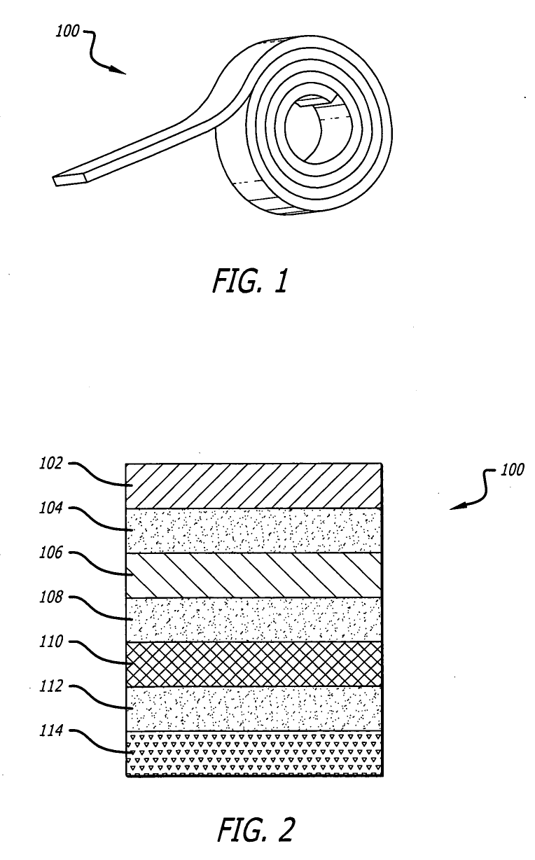

### DETAILED DESCRIPTION

The present inventor has discovered that laminated materials preventing the types of failures detailed above can be simply and elegantly generated to address the longstanding needs existing among the prior art. The laminates of the instant teachings include more than one layer of coated or uncoated glass cloth laminated with a metal foil with high temperature inorganic silicone based adhesives—both pigmented and unpigmented.

What is unexpectedly better than dictated by empirical data are the excellent conformability and sealing properties, including the self-attachment achieved with the instant laminates. An ability to withstand extreme high temperatures and high fuel velocity up to a magnitude of at least about 21,000 miles per hour is likewise believed to differentiate the instant teachings from known art in novelty terms, as discussed herein, illustrated by the schematic and exemplary versions of the embodiments presented as figures and defined by the claimed appended. According to embodiments of the teachings of the present disclosure, there is disclosed a silicone pressure sensitive adhesive which, used according to the instant processes retained physical properties like adhesion to surfaces and to its own backing after being exposed to extreme conditions in testing.

The composition of silicone pressure sensitive adhesives (PSA) is similar to many common organic PSAs. However, silicone PSAs are appropriate in high temperature applications in which organic PSAs fail. The characteristics that dictate the performance of silicone PSAs are high molecular weight linear siloxane polymers and a highly condensed silicate tackifying resin, such as MQ resin. An example of a typical silicone polymer used in the present disclosure is: 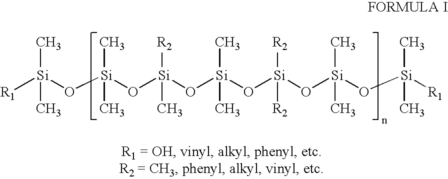
Typical commercially available silicone PSAs are polydimethylsiloxane (PDMS) polymer, polydiphenylsiloxane (PDPS) polymer, and polydimethyldiphenylsiloxane (PDMDPS) polymer, which have silanol or vinyl functional groups at the polymer chain ends.

MQ is a silicate resin commercially available as a solid suspended in a hydrocarbon solvent and is disclosed in U.S. Pat. No. 5,330,747, which is hereby expressly incorporated by reference as if fully set forth herein. It comprises a core of SiO_{4/2} “Q” units, which are surrounded by a shell of Me₃SiO “M” units. MQ units undergo a condensation reaction with a siloxane polymer due to silanol functional groups in the shell, forming a covalent bond between the MQ resin and the siloxane polymer. The ratio of resin to polymer must optimized for each application, but can done without undue experiments by a person of ordinary skill in the art.

Adhesion of PSAs in a pressure sensitive manner occurs by removing solvents. To increase and reinforce the adhesion network, the PSAs may be cured. PSA curing systems are commercially available. One system is a peroxide-catalyzed free-radical cure system. It uses either benzoyl peroxide or 2,4-dichlorobenzoyl peroxide. The details of these systems are well known in the art. Another common system contemplated by the present disclosure for curing PSAs is a platinum-based system, which is also commercially available and well-known in the art. The advantage of platinum-based systems are the lack byproducts and the ability to cure while evaporating the solvent at low temperature.

The present disclosure is a process for making a multilayered laminated HVOF tape which comprises, attaching a plurality of layers of glass cloth laminated with metal foils, aramid paper, or ceramic papers with high temperature inorganic silicone based adhesives, and finishing a resulting HVOF tape which provides for high strength and non-flammable resistance to high temperature, high velocity, and high pressure when used during an HVOF process. Using this process, it is further understood that in certain instances of the process above, the attaching step further includes a first silicone rubber coating, followed by a woven or non-woven high temperature fabric, a laminating adhesive, a metal foil, another layer of laminating adhesive, and a woven or non-woven high temperature fabric, a silicone pressure sensitive adhesive and an optional release liner. Similarly, the product, produced by the process of described above works whereby the plurality of layers in the attaching step further includes a first silicone rubber coating, followed by a laminating adhesive, a metal foil, another layer of laminating adhesive, a woven or non-woven high temperature fabric, a silicone pressure sensitive adhesive, and an optional release liner.

The present disclosure likewise contemplates that in a product, produced by the above process, the plurality of layers in the attaching step further includes a first silicone rubber coating, followed by a woven or non-woven high temperature fabric; a laminating adhesive; a metal foil, ceramic paper, polyamide paper; a silicone pressure sensitive adhesive; and an optional release liner.

In another and alternative construction, a laminated assembly is disclosed wherein there is a laminated HVOF tape comprised of at least coated and uncoated glass cloth and ceramic based fabric laminated to one or both sides of at least one foil selected from the group consisting of copper, steel, aluminum, and other metal foils with a silicone laminating adhesive, which is then again laminated with another layer of woven or nonwoven glass cloth or ceramic based fabric which is coated with a high temperature silicone pressure sensitive adhesive and wound to itself to make a self wound HVOF tape.

Yet still another embodiment according to the present disclosure is shown, wherein the laminated HVOF tape product is comprised of at least one of coated and uncoated glass cloth and ceramic based fabric laminated to one or both sides of at least one foil selected from the group consisting of copper, steel, aluminum, and other metal foils with a silicone laminating adhesive which is then again laminated with another layer of woven or non woven glass cloth or ceramic based fabric which is coated with a high temperature silicone pressure sensitive adhesive and wound to itself to make a laminated sheet, or to make an assembly from which die cut samples may be made.

### EXAMPLE 1

FIG. 2 demonstrates an embodiment of HVOF tape 100 construction. According to FIG. 2, HVOF tape 100 construction comprises a plurality of layers: first layer 102, second layer 104, third layer 106, first adhesive 108, glass cloth 110, second adhesive 112, and release liner 114.

First layer 102 is a pressure sensitive layer made from a polydimethylsiloxane (PDMS) polymer, polydiphenylsiloxane (PDPS) polymer, or a polydimethyldiphenylsiloxane (PDMDPS) polymer. In an embodiment, MQ resin may optionally be added as a tackifying agent. Moreover, a release liner (not shown) is optional in the configuration where first layer 102 is a pressure sensitive adhesive.

Optionally, first layer 102 may be a pressure insensitive (pressure insensitive defined to be not pressure sensitive) silastic coating, which is a non-tacky silicone rubber or elastomer coating. Additionally, first layer 102 may be a PDMS, PDPS, or PDMDPS polymer having a nonorganic fire resistant filler. Nonorganic fire resistant fillers may be ceramic powder, metal, glass, metal oxides, or combinations of ceramic powder, metal, glass, or metal oxide fillers. Examples of fire resistant fillers contemplated by the present disclosure are ferro oxide, titanium oxide, boron nitride, zirconium oxide, sodium silicate, and magnesium silicate, although others are suitable as well.

First layer 102 may also be a nonthermally conductive material, in embodiments. An example of a nonthermally conductive material is zirconium woven cloth or felt. Zirconium is defined to be a material comprising 50% to 100% ZrO₂. A more effective embodiment comprises 70% to 100% ZrO₂.

In another embodiment, the nonthermally conductive material is a siloxane-based foam that is either pressure sensitive or pressure insensitive, comprising the siloxane-based foam with a density of about 0.01 to about 1.00 g/cm³. The foam may optionally include at least one non-flammable filler, which may be ceramic powder, metal, glass, metal oxides, or combinations of ceramic powder, metal, glass, or metal oxide fillers. Examples of fire resistant fillers contemplated by the present disclosure are ferro oxide, titanium oxide, boron nitride, zirconium oxide, sodium silicate, and magnesium silicate, although others are suitable as well.

Second layer 104 is an optional laminating layer depending on how well first layer 102 adheres to third layer 106. However, when included, second layer comprises an adhesive bonding first layer to third layer, such as a PDMS, PDPS, PDMDPS-based pressure sensitive adhesive or a PDMS, PDPS, PDMDPS-based adhesive that is pressure insensitive at room temperature.

Third layer 106 is also an optional layer comprising a metal film or foil. The present disclosure contemplates using an aluminum foil, steel foil, copper foil, or other types of metal foil. In other embodiments, metal foil is substituted with wool paper, polyamide paper, carbon paper, ceramic paper, or polyamide felt. The layer should be about 0.1 mm to about 5.00 mm thick. In a particularly effective embodiment, copper foil of thickness of about 0.025 mm to about 0.13 mm is used.

First adhesive 108 is a PDMS, PDPS, or PDMDPS polymer based adhesive. It must be able to adhere to whatever components form first layer 102, second layer 104, or third layer 106 and glass cloth 110. First adhesive 108 works well as both a pressure sensitive adhesive or a pressure insensitive adhesive. The adhesive may optionally include at least one non-flammable additive, which may be ceramic powder, metal, glass, metal oxides, or combinations of ceramic powder, metal, glass, or metal oxide additives. Examples of fire resistant additives contemplated by the present disclosure are ferro oxide, titanium oxide, boron nitride, zirconium oxide, sodium silicate, and magnesium silicate, although others are suitable as well.

Glass cloth 110 is a woven or felt cloth made of glass fiber, silicate fiber, ceramic fiber, aramid fiber, polyamide fiber, or carbon fiber.

Like first adhesive 108, second adhesive 112 is a PDMS, PDPS, or PDMDPS polymer based adhesive. It may either be a pressure sensitive adhesive or a pressure insensitive adhesive. A particularly effective embodiment is a pressure sensitive adhesive uses a PDPS polymer based adhesive. The adhesive may optionally include at least one non-flammable additive, which may be ceramic powder, metal, glass, metal oxides, or combinations of ceramic powder, metal, glass, or metal oxide additives. Examples of fire resistant additives contemplated by the present disclosure are ferro oxide, titanium oxide, boron nitride, zirconium oxide, sodium silicate, and magnesium silicate, although others are suitable as well.

Finally, release liner 114 may take a number of forms in embodiments. For example, it may be a thin layer web that covers second adhesive 112. Alternately, it may be corrugated or embossed film, such as polyolefin or PVC. It may also be a smooth plastic film or paper coated with a flourosilicone coated release layer that does not bond to second adhesive 112. Release liner 114 should be able to be easily and manually removed from second adhesive 112 without changing the physical or functional properties of second adhesive 112. Other release liners having similar properties are similarly contemplated as would be known to those skilled in the art.

### EXAMPLE 2

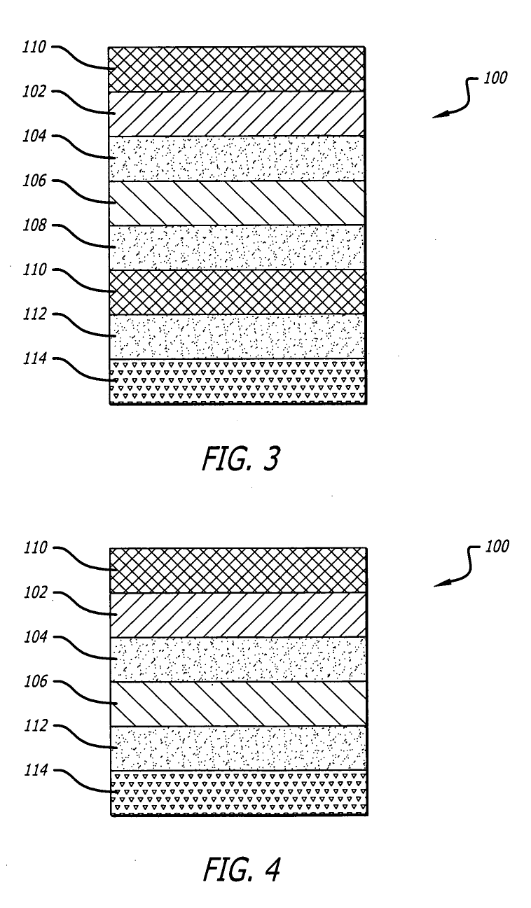

FIG. 3 shows an alternative embodiment of an HVOF tape 100. The alternative embodiment comprises: glass cloth 110, first layer 102, second layer 104, third layer 106, first adhesive 108, glass cloth 110, second adhesive 112, and release liner 114. The exemplary embodiment is the same as the exemplary embodiment disclosed in EXAMPLE 1, with the exception that glass cloth layer 110, as previously defined, comprises the top-most layer rather than first layer 102.

Because glass layer is the topmost layer, first layer 102 is modified to be a pressure sensitive adhesive layer made from PDMS polymer, PDPS polymer, or PDMDPS polymer serving as an adhesive binding glass cloth 110 to the other layers. In an embodiment, MQ resin may optionally be added to first layer 102 as a tackifying agent. Optionally, first layer may be a PDMS, PDPS, or PDMDPS polymer having a nonorganic fire resistant additive. Nonorganic fire resistant additives may be ceramic powder, metal, glass, metal oxides, or combinations of ceramic powder, metal, glass, or metal oxide additives. Examples of fire resistant additives contemplated by the present disclosure are ferro oxide, titanium oxide, boron nitride, zirconium oxide, sodium silicate, and magnesium silicate, although others are suitable as well. First layer 102 may also be a pressure insensitive silastic coating, which is a non-tacky silicone rubber or elastomer coating.

### EXAMPLE 3

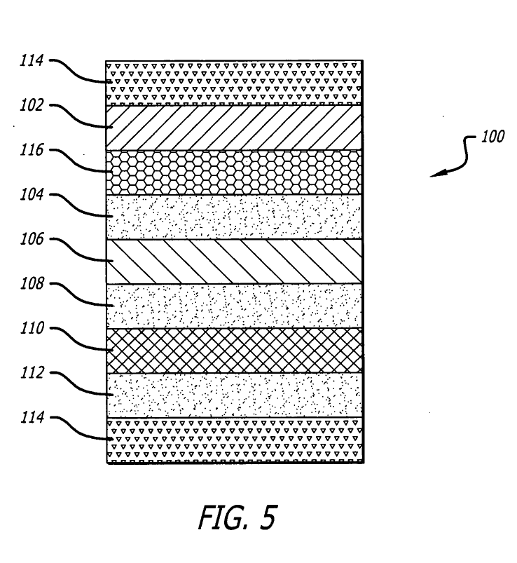

FIG. 4 demonstrates a third embodiment for constructing HVOF tape 100. The exemplary embodiment comprises glass cloth 110, first layer 102, second layer 104, third layer 106, second adhesive 112, and release liner 114. The embodiment is the same as that of EXAMPLE 2, except that third layer 106 is must be included and glass cloth 110 layer and its laminating adhesive, first adhesive 108, are excluded. All other features are the same as in EXAMPLE 2.

### EXAMPLE 4

A fourth embodiment exemplified by FIG. 5 of the present disclosure comprises HVOF tape 100 identical to the embodiment taught in EXAMPLE 1, except that first layer 102 comprises both a high temperature silicone PSA. Moreover, between first layer 102 and second layer 104 is high temperature fabric or foam 116, as previously described. Release liners 114 are used on both sides of the HVOF tape bordering high temperature silicone PSA layers 102 and 112.

The present inventor has disclosed that the material characteristics necessary to transform conventional tapes into HVOF tape, which provides interesting and useful results when optimized. Unexpectedly improved products have consequently been developed using the results set forth in the following tables in the process of optimizing the instant teachings.

TABLE 1

| | Tape Example Code | | | | |
|---|---|---|---|---|---|
| | 1259A | 1259B | 1260 | 1261 | 1262 |
| Tape | Glass fiber | Glass fiber cloth | Glass fiber cloth | Glass fiber | Glass fiber cloth |
| Construction | cloth | Silastic Rubber | Silicone | cloth | Silastic Rubber |
| | Silastic | Coating | lamination | Silastic | Coating |
| | Rubber | Silicone | adhesive | Rubber | Silicone |
| | Coating | lamination | 2 mil aluminum | Coating | lamination |
| | Silicone | adhesive | foil | Silicone | adhesive |
| | lamination | 2 mil aluminum | Silicone | lamination | 2 mil aluminum |
| | adhesive | foil | Silicone | adhesive | foil |
| | 2 mil | Silicone | lamination | 2 mil | PDMDPS |
| | aluminum foil | lamination | adhesive | aluminum foil | pressure |
| | Silicone | adhesive | Glass fiber cloth | PDMS | sensitive |
| | lamination | Glass fiber cloth | PDMDPS | pressure | adhesive |
| | adhesive | PDMDPS | pressure | sensitive | Fluorosilicone |
| | Glass fiber | pressure | sensitive | adhesive | PET release |
| | cloth | sensitive | adhesive | | liner |
| | PDMS | adhesive | | | |
| | pressure | | | | |
| | sensitive | | | | |
| | adhesive | | | | |
| Adhesion to | 53 | 61 | 60 | 63 | 48 |
| Steel (oz/in) | | | | | |
| Adhesion to | 31 | 40 | 28 | 29 | 35 |
| Backing | | | | | |
| (oz/in) | | | | | |
| Probe tack | 950 | 1500 | 1000 | 1440 | 1200 |
| (grams) | | | | | |
| Rolling Ball | 0.35 | 0.35 | 0.4 | 0.55 | 0.4 |
| Tack (inches) | | | | | |
| Oxy/Propane | good | good | fair-good | fair | fair-good |
| thermal test | | | | | |
| (3 minutes) | | | | | |

Table 1 shows exemplary embodiments and their respective strengths with respect to key parameters of the instant disclosure. Table 2 demonstrates variations in the formulation of silicone adhesive and silastic silicone rubber layers reviewed in completion of the teachings of the instant disclosure. Units of the layers are in parts per total weight (e.g. the total weight of HVOF tape example 1043 is 105 parts, wherein 100 parts are PDMP Silicone PSA and 5 parts benzoyl peroxide).

TABLE 2
The following describes possible silicone adhesive and Silastic silicone rubber formulations.

| | | Tape Example Code | | |
|---|---|---|---|---|
| | Tape Construction Components | 1043 A | 1043A1 | 1043 B |
| Adhesive Layer | PDMDP Silicone PSA | 100 | 100 | |
| | PDP Silicone PSA | | | |
| | PDM Silicone PSA | | | 100 |
| | Benzoyl Peroxide | 5 | 10 | 5 |
| Silastic silicone | Silicone rubber A | | | |
| rubber Layer | Ferro Oxide | | | |
| | Silicone rubber B | | | |
| | Titanium Oxide | | | |
| | Boron Nitride | | | |
| | Zirconium Oxide | | | |
| | Sodium Silicate | | | |
| | Magnesium Silicate | | | |
| Tape Construction | | glass fiber cloth | glass fiber cloth | glass fiber cloth |
| | | Silicone adhesive | Silicone adhesive | Silicone adhesive |
| | | 3 mil aluminum foil | 3 mil aluminum foil | 3 mil aluminum foil |
| | | Silicone adhesive | Silicone adhesive | Silicone adhesive |
| | | glass fiber cloth | glass fiber cloth | glass fiber cloth |
| | | Silicone PSA | Silicone PSA | Silicone PSA |
| Tape Properties | Adhesion to Steel (oz/in) | 55 | 50 | 65 |
| | Adhesion to Backing (oz/in) | 31 | 30 | 45 |
| | Probe tack (grams) | 950 | 900 | 860 |
| | Rolling Ball Tack(inches) | 0.35 | 0.45 | 0.45 |
| | Oxy/Propane thermal test (3 | good | good | good |
| | minutes) | | | |
| | | Tape Example Code | | |
| | Tape Construction Components | 1043 B1 | 1044 C | 1044 D |
| Adhesive Layer | PDMDP Silicone PSA | | | |
| | PDP Silicone PSA | | | |
| | PDM Silicone PSA | 100 | 100 | 100 |
| | Benzoyl Peroxide | 10 | 10 | 10 |
| Silastic silicone | Silicone rubber A | | 100 | |
| rubber Layer | Ferro Oxide | | 50 | |
| | Silicone rubber B | | | 100 |
| | Titanium Oxide | | | 50 |
| | Boron Nitride | | | |
| | Zirconium Oxide | | | |
| | Sodium Silicate | | | |
| | Magnesium Silicate | | | |
| Tape Construction | | glass fiber cloth | Silastic silicone | Silastic silicone |
| | | Silicone adhesive | rubber | rubber |
| | | 3 mil aluminum foil | glass fiber cloth | glass fiber cloth |
| | | Silicone adhesive | Silicone adhesive | Silicone adhesive |
| | | glass fiber cloth | 3 mil aluminum foil | 3 mil aluminum foil |
| | | Silicone PSA | Silicone adhesive | Silicone adhesive |
| | | | glass fiber cloth | glass fiber cloth |
| | | | Silicone PSA | Silicone PSA |
| Tape Properties | Adhesion to Steel (oz/in) | 60 | 62 | 60 |
| | Adhesion to Backing (oz/in) | 43 | 38 | 40 |
| | Probe tack (grams) | 910 | 900 | 910 |
| | Rolling Ball Tack(inches) | 0.4 | 0.4 | 0.4 |
| | Oxy/Propane thermal test (3 | good | good | good |
| | minutes) | | | |
| | | Tape Example Code | | |
| | Tape Construction Components | 1044 E | 1044 D | 1045 D |
| Adhesive Layer | PDMDP Silicone PSA | 100 | | |
| | PDP Silicone PSA | | 100 | 100 |
| | PDM Silicone PSA | | | |
| | Benzoyl Peroxide | 10 | 10 | 10 |
| Silastic silicone | Silicone rubber A | 100 | | |
| rubber Layer | Ferro Oxide | 50 | | |
| | Silicone rubber B | | 100 | 100 |
| | Titanium Oxide | | 20 | 100 |
| | Boron Nitride | | | |
| | Zirconium Oxide | | | |
| | Sodium Silicate | | | |
| | Magnesium Silicate | | | |
| Tape Construction | | Silastic silicone | Silastic silicone | Silastic silicone |
| | | rubber | rubber | rubber |
| | | glass fiber cloth | glass fiber cloth | glass fiber cloth |
| | | Silicone adhesive | Silicone adhesive | Silicone adhesive |
| | | 3 mil aluminum foil | 3 mil aluminum foil | 3 mil aluminum foil |
| | | Silicone adhesive | Silicone adhesive | Silicone adhesive |
| | | glass fiber cloth | glass fiber cloth | glass fiber cloth |
| | | Silicone PSA | Silicone PSA | Silicone PSA |
| Tape Properties | Adhesion to Steel (oz/in) | 53 | 55 | 54 |
| | Adhesion to Backing (oz/in) | 32 | 30 | 35 |
| | Probe tack (grams) | 900 | 850 | 880 |
| | Rolling Ball Tack(inches) | 0.3 | 0.35 | 0.3 |
| | Oxy/Propane thermal test (3 | good | good | good |
| | minutes) | | | |
| | | Tape Example Code | | |
| | Tape Construction Components | 1046 D | 1047 D | 1048 D |
| Adhesive Layer | PDMDP Silicone PSA | | | |
| | PDP Silicone PSA | 100 | 100 | 100 |
| | PDM Silicone PSA | | | |
| | Benzoyl Peroxide | 10 | 10 | 10 |
| Silastic silicone | Silicone rubber A | | | |
| rubber Layer | Ferro Oxide | | | |
| | Silicone rubber B | 100 | 100 | 100 |
| | Titanium Oxide | | | |
| | Boron Nitride | 20 | 100 | |
| | Zirconium Oxide | | | 20 |
| | Sodium Silicate | | | |
| | Magnesium Silicate | | | |
| Tape Construction | | Silastic silicone | Silastic silicone | Silastic silicone |
| | | rubber | rubber | rubber |
| | | glass fiber cloth | glass fiber cloth | glass fiber cloth |
| | | Silicone adhesive | Silicone adhesive | Silicone adhesive |
| | | 3 mil aluminum foil | 3 mil aluminum foil | 3 mil aluminum foil |
| | | Silicone adhesive | Silicone adhesive | Silicone adhesive |
| | | glass fiber cloth | glass fiber cloth | glass fiber cloth |
| | | Silicone PSA | Silicone PSA | Silicone PSA |
| Tape Properties | Adhesion to Steel (oz/in) | 52 | 53 | 55 |
| | Adhesion to Backing (oz/in) | 29 | 33 | 35 |
| | Probe tack (grams) | 800 | 790 | 820 |
| | Rolling Ball Tack(inches) | 0.29 | 0.3 | 0.33 |
| | Oxy/Propane thermal test (3 | good | good | good |
| | minutes) | | | |
| | | Tape Example Code | | |
| | Tape Construction Components | 1049 D | 1050 D | 1051 D |
| Adhesive Layer | PDMDP Silicone PSA | | | |
| | PDP Silicone PSA | 100 | 100 | 100 |
| | PDM Silicone PSA | | | |
| | Benzoyl Peroxide | 10 | 10 | 10 |
| Silastic silicone | Silicone rubber A | | | |
| rubber Layer | Ferro Oxide | | | |
| | Silicone rubber B | 100 | 100 | 100 |
| | Titanium Oxide | | | |
| | Boron Nitride | | | |
| | Zirconium Oxide | 100 | | |
| | Sodium Silicate | | 20 | 100 |
| | Magnesium Silicate | | | |
| Tape Construction | | Silastic silicone | Silastic silicone | Silastic silicone |
| | | rubber | rubber | rubber |
| | | glass fiber cloth | glass fiber cloth | glass fiber cloth |
| | | Silicone adhesive | Silicone adhesive | Silicone adhesive |
| | | 3 mil aluminum foil | 3 mil aluminum foil | 3 mil aluminum foil |
| | | Silicone adhesive | Silicone adhesive | Silicone adhesive |
| | | glass fiber cloth | glass fiber cloth | glass fiber cloth |
| | | Silicone PSA | Silicone PSA | Silicone PSA |
| Tape Properties | Adhesion to Steel (oz/in) | 58 | 52 | 55 |
| | Adhesion to Backing (oz/in) | 36 | 30 | 32 |
| | Probe tack (grams) | 810 | 790 | 830 |
| | Rolling Ball Tack(inches) | 0.34 | 0.3 | 0.32 |
| | Oxy/Propane thermal test (3 | good | good | good |
| | minutes) | | | |
| | | Tape Example Code | | |
| | Tape Construction Components | 1052 D | 1053 D | 1054 D |
| Adhesive Layer | PDMDP Silicone PSA | | | |
| | PDP Silicone PSA | 100 | 100 | 100 |
| | PDM Silicone PSA | | | |
| | Benzoyl Peroxide | 10 | 10 | 10 |
| Silastic silicone | Silicone rubber A | | | |
| rubber Layer | Ferro Oxide | | | |
| | Silicone rubber B | 100 | 100 | 100 |
| | Titanium Oxide | | | |
| | Boron Nitride | | | |
| | Zirconium Oxide | | | |
| | Sodium Silicate | | | |
| | Magnesium Silicate | 20 | 100 | 50 |
| Tape Construction | | Silastic silicone | Silastic silicone | Silastic silicone |
| | | rubber | rubber | rubber |
| | | glass fiber cloth | glass fiber cloth | 5 mil copper foil |
| | | Silicone adhesive | Silicone adhesive | Silicone adhesive |
| | | 3 mil aluminum foil | 3 mil aluminum foil | 3 mil aluminum foil |
| | | Silicone adhesive | Silicone adhesive | Silicone adhesive |
| | | glass fiber cloth | glass fiber cloth | glass fiber cloth |
| | | Silicone PSA | Silicone PSA | Silicone PSA |
| Tape Properties | Adhesion to Steel (oz/in) | 51 | 56 | 57 |
| | Adhesion to Backing (oz/in) | 33 | 33 | 34 |
| | Probe tack (grams) | 820 | 850 | 850 |
| | Rolling Ball Tack(inches) | 0.33 | 0.35 | 0.35 |
| | Oxy/Propane thermal test (3 | good | very good | good |
| | minutes) | | | |
| | | Tape Example Code | | |
| | Tape Construction Components | 1055 D | 1056 D | 1057 D |
| Adhesive Layer | PDMDP Silicone PSA | | | |
| | PDP Silicone PSA | 100 | 100 | 100 |
| | PDM Silicone PSA | | | |
| | Benzoyl Peroxide | 10 | 10 | 10 |
| Silastic silicone | Silicone rubber A | | | |
| rubber Layer | Ferro Oxide | | | |
| | Silicone rubber B | 100 | 100 | 100 |
| | Titanium Oxide | | | |
| | Boron Nitride | | | |
| | Zirconium Oxide | | | |
| | Sodium Silicate | 50 | 100 | |
| | Magnesium Silicate | | | 100 |
| Tape Construction | | Silastic silicone | Silastic silicone | Silastic silicone |
| | | rubber | rubber | rubber |
| | | 2 mil copper foil | 3 mil aluminum foil | 5 mil aluminum foil |
| | | Silicone adhesive | Silicone adhesive | Silicone adhesive |
| | | 4 mil aluminum foil | 5 mil aluminum foil | 6 mil aluminum foil |
| | | Silicone adhesive | Silicone adhesive | Silicone adhesive |
| | | glass fiber cloth | glass fiber cloth | glass fiber cloth |
| | | Silicone PSA | Silicone PSA | Silicone PSA |
| Tape Properties | Adhesion to Steel (oz/in) | 57 | 50 | 52 |
| | Adhesion to Backing (oz/in) | 32 | 30 | 31 |
| | Probe tack (grams) | 840 | 780 | 790 |
| | Rolling Ball Tack(inches) | 0.33 | 0.3 | 0.3 |
| | Oxy/Propane thermal test (3 | very good | very good | very good |
| | minutes) | | | |
| | | Tape Example Code | | |
| | Tape Construction Components | 1058 D | 1059 D | 1060 D |
| Adhesive Layer | PDMDP Silicone PSA | 100 | 100 | 100 |
| | PDP Silicone PSA | | | |
| | PDM Silicone PSA | | | |
| | Benzoyl Peroxide | 10 | 10 | 10 |
| Silastic silicone | Silicone rubber A | 100 | 100 | 100 |
| rubber Layer | Ferro Oxide | | | |
| | Silicone rubber B | | | |
| | Titanium Oxide | | | |
| | Boron Nitride | | | |
| | Zirconium Oxide | | | |
| | Sodium Silicate | 50 | 50 | 50 |
| | Magnesium Silicate | | | |
| Tape Construction | | Silastic silicone | Silastic silicone | 10 mil copper foil |
| | | rubber | rubber | Silastic silicone |
| | | 5 mil copper foil | 6 mil copper foil | rubber |
| | | Silicone adhesive | Silicone adhesive | 3 mil aluminum foil |
| | | glass fiber cloth | 4 mil aluminum foil | Silicone adhesive |
| | | Silicone PSA | Silicone PSA | glass fiber cloth |
| | | | | Silicone PSA |
| Tape Properties | Adhesion to Steel (oz/in) | 50 | 52 | 66 |
| | Adhesion to Backing (oz/in) | 34 | 30 | 34 |
| | Probe tack (grams) | 850 | 810 | 860 |
| | Rolling Ball Tack(inches) | 0.35 | 0.32 | 0.35 |
| | Oxy/Propane thermal test (3 | good | good | very good |
| | minutes) | | | |

| | | Tape Example Code |
|---|---|---|
| | Tape Construction Components | 1060 D |
| Adhesive Layer | PDMDP Silicone PSA | 100 |
| | PDP Silicone PSA | |
| | PDM Silicone PSA | |
| | Benzoyl Peroxide | 10 |
| Silastic silicone | Silicone rubber A | 100 |
| rubber Layer | Ferro Oxide | |
| | Silicone rubber B | |
| | Titanium Oxide | |
| | Boron Nitride | |
| | Zirconium Oxide | |
| | Sodium Silicate | 50 |
| | Magnesium Silicate | |
| Tape Construction | | 10 mil copper foil |
| | | Silastic silicone |
| | | rubber |
| | | 6 mil aluminum foil |
| | | Silicone adhesive |
| | | glass fiber cloth |
| | | Silicone PSA |
| Tape Properties | Adhesion to Steel (oz/in) | 68 |
| | Adhesion to Backing (oz/in) | 32 |
| | Probe tack (grams) | 850 |
| | Rolling Ball Tack(inches) | 0.35 |
| | Oxy/Propane thermal test (3 | good |
| | minutes) | |

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A multilayered laminated tape comprising, in combination:
a plurality of layers including at least:
(i) a first layer;
(ii) a third layer;
(iii) a first adhesive layer;
(iv) a glass cloth layer, the glass cloth layer being at least one of a glass fiber and a ceramic fiber;
(v) a second adhesive layer;
wherein the resulting tape which provides for high strength and non-flammable resistance to high temperature, high velocity, and high pressure when used during an HVOF process.

2. The tape of claim 1, wherein the third layer comprises at least one of the group of materials consisting of: wool paper, polyamide paper, and polyamide woven fabric.

3. The tape of claim 1, wherein the third layer comprises at least one of the group consisting of: aluminum foil, steel foil, and copper foil.

4. The tape of claim 1, further comprising a second glass cloth layer, wherein the first layer rests between the second glass cloth layer and the second layer and wherein the second glass cloth layer is a glass fiber or a ceramic fiber.

5. The tape of claim 1, further comprising a second layer, wherein the second layer is a silicone adhesive used to improve bonding the first layer to the third layer and wherein the second layer is a silicone based adhesive.

6. The tape of claim 1, further comprising at least one release liner.

7. The tape of claim 4, further comprising at least one release liner.

8. The tape of claim 1, wherein the first layer is a silastic coating.

9. The tape of claim 1, wherein the first layer is a non-thermally conductive material.

10. The tape of claim 9, wherein the non-thermally conductive material is ZrO₂ woven cloth or ZrO₂ felt, wherein the ZrO₂ is present in the cloth or felt between 50%-100%.

11. The tape of claim 1, wherein the first layer is a siloxane based foam with a density of about 0.01 g/cm³ to about 1.00 g/cm³, wherein the foam may have at least one non-organic non-thermally conductive fillers;
wherein the non-organic non-thermally conductive filler is at least one of: metal, glass, ceramic powder, non-metal oxide, and metal oxide.

12. The tape of claim 1, wherein the first layer is a silicone material comprising at least one non-organic non-thermally conductive filler,
wherein the silicone material is one of PDMS, PDPS, or PDMDPS; and
wherein the non-organic filler is at least one of: metal, glass, ceramic powder, non-metal oxide, and metal oxide.

13. The tape of claim 11, wherein the non-organic filler is one of ferro oxide, titanium oxide, boron nitride, zirconium oxide, sodium silicate, and magnesium silicate.

14. A10. The tape of claim 12, wherein the non-organic filler is one of ferro oxide, titanium oxide, boron nitride, zirconium oxide, sodium silicate, and magnesium silicate.

15. The tape of claim 1, wherein first adhesive layer is one of PDMS, PDPS, and PDMDPS; and
wherein second adhesive layer is one of PDMS, PDPS, and PDMDPS.

16. The tape of claim 1, wherein at least lease one of first adhesive and second adhesive is pressure sensitive.

17. The tape of claim 1, wherein MQ resin is used as a tackifying agent.

18. The tape of claim 1, wherein the tape has the ability to withstand extreme high temperatures and high fuel velocity up to a magnitude of at least 21,000 miles per hour.

19. The tape of claim 1, wherein the glass cloth layer is substituted with an additional third layer comprising at least one of the group of materials consisting of: wool paper, polyamide paper, and polyamide woven fabric.

20. The tape of claim 1, wherein the glass cloth layer is substituted with an additional third layer comprising at least one of the group of materials consisting of: aluminum foil, steel foil, and copper foil.

21. A multilayered laminated tape comprising, in combination:
a plurality of layers including having at least:
(i) a glass cloth layer;
(ii) a first layer;
(iii) a third layer;
(iv) a second adhesive layer;
wherein the resulting tape which provides for high strength and non-flammable resistance to high temperature, high velocity, and high pressure when used during an HVOF process.

22. The tape of claim 21, further comprising a second glass cloth layer, wherein the first layer rests between the second glass cloth layer and the second layer and wherein the second glass cloth layer is a glass fiber or a ceramic fiber.

23. The tape of claim 21, further comprising a second layer, wherein the second layer is a silicone adhesive used to improve bonding the first layer to the third layer and wherein the second layer is a silicone based adhesive.

24. The tape of claim 21, wherein the third layer comprises any one of the group consisting of: wool paper, polyamide paper, and polyamide woven fabric.

25. The tape of claim 21, wherein the third layer is at least one of the group consisting of: aluminum foil, steel foil, and copper foil.

26. The tape of claim 21, further comprising at least one release liner.

27. The tape of claim 22, further comprising at least one release liner.

28. The tape of claim 21, wherein the first layer is a silastic coating.

29. The tape of claim 21, wherein the first layer is a non-thermally conductive material.

30. The tape of claim 29, wherein the non-thermally conductive material is ZrO₂ woven cloth or ZrO₂ felt, wherein the ZrO₂ is present in the cloth or felt between 50%-100%.

31. The tape of claim 2, wherein the first layer is a siloxane based foam with a density of about 0.01 g/cm³ to about 1.00 g/cm³, wherein the foam may have at least one non-organic non-thermally conductive fillers;
wherein the non-organic non-thermally conductive filler is at least one of: metal, glass, ceramic powder, non-metal oxide, and metal oxide.

32. The tape of claim 21, wherein the first layer is a silicone material comprising at least one non-organic non-thermally conductive filler,
wherein the silicone material is one of PDMS, PDPS, or PDMDPS; and
wherein the non-organic filler is at least one of: metal, glass, ceramic powder, non-metal oxide, and metal oxide.

33. The tape of claim 31, wherein the non-organic filler is one of ferro oxide, titanium oxide, boron nitride, zirconium oxide, sodium silicate, and magnesium silicate.

34. A10. The tape of claim 32, wherein the non-organic filler is one of ferro oxide, titanium oxide, boron nitride, zirconium oxide, sodium silicate, and magnesium silicate.

35. The tape of claim 21, wherein first adhesive layer is one of PDMS, PDPS, and PDMDPS; and
wherein second adhesive layer is one of PDMS, PDPS, and PDMDPS.

36. The tape of claim 21, wherein at least lease one of first adhesive and second adhesive is pressure sensitive.

37. The tape of claim 21, wherein MQ resin is used as a tackifying agent.

38. The tape of claim 21, wherein the tape has the ability to withstand extreme high temperatures and high fuel velocity up to a magnitude of at least 21,000 miles per hour.

39. A multilayered laminated tape comprising, in combination:
a first release liner;
a first high temperature silicone pressure sensitive adhesive;
one of a first high temperature fabric and a high temperature foam;
a first laminating adhesive;
one of a metal foil and a foam;
a second laminating adhesive;
a second high temperature fabric;
a second high temperature silicone pressure sensitive adhesive; and
a second release liner.

40. The tape of claim 39, wherein the first high temperature silicone pressure sensitive adhesive and the second high temperature pressure sensitive adhesive are diphenyl siloxane adhesives compounded with one of MQ resin or boron nitride and crosslinked with benzoyl peroxide.

41. The tape of claim 39, wherein at least one of first release liner and second release liner are not present.

42. The tape of claim 39, wherein the tape has the ability to withstand extreme high temperatures and high fuel velocity up to a magnitude of at least 21,000 miles per hour.
